(19) United States
(12) Patent Application Publication
(10) Pub. No.: US 2021/0240050 A1
(43) Pub. Date: Aug. 5, 2021

(54) Integrated Modulator Structure for In-situ Power Balancing in Photonic Fiber Optic Gyroscopes

(71) Applicant: KVH Industries, Inc., Middletown, RI (US)

(72) Inventor: Jan Amir Khan, Windsor, CT (US)

(21) Appl. No.: 17/161,064

(22) Filed: Jan. 28, 2021

Related U.S. Application Data
(60) Provisional application No. 62/967,729, filed on Jan. 30, 2020.

(51) Int. Cl. G02F 1/21; G02F 1/225; G01C 19/72

(52) U.S. Cl. CPC G02F 1/212; G01C 19/721; G01C 19/725; G02F 1/2252

(57) ABSTRACT

A light amplitude balancing system for use in a photonic integrated circuit (PIC)-based fiber optic gyroscope (FOG) may comprise one or more 2×2 PIC-based FOG optical circuits and a PIC-based modulator assembly. The modulator assembly may be configured to receive one or more input light signals, and to produce one or more output light signals that (i) correspond to the input light signals and (ii) are conveyed to the one or more FOG optical circuits. Each of the one or more output light signals may have an amplitude that is a modified version of an amplitude of the corresponding input signal. The one or more FOG optical circuits and the PIC-based modulator assembly may be disposed on a common PIC substrate. Alternatively, the one or more FOG optical circuits may be disposed on a first PIC substrate, and the PIC-based modulator assembly may be disposed on a second PIC substrate.

### RELATED APPLICATION

This application claims the benefit of U.S. Provisional Application No. 62/967,729, filed on Jan. 30, 2020. The entire teachings of the above application are incorporated herein by reference.

### BACKGROUND

Open loop fiber optics gyroscopes (FOGs) are susceptible to power fluctuations of the sensor source. Short term power fluctuations manifest themselves as bias error at the rate sensor output. Power fluctuations therefore present a direct degradation of bias stability and provides erroneous output. Open loop gyroscopes require very precise power maintenance procedures to maintain power levels that do not change rapidly with respect to time.

The phase measurement of a FOG in the unbiased condition can be represented as follows:

$${ΔΘ}_{R} = \frac{{P}_{0}}{2} [ 1 + COS ( {ΔΘ}_{S} ) ] ,$$

where ΔΘ_{R} is the measured phase difference of the interferometer corresponding to the rotation rate, ΔΘ_{S} is the Sagnac phase, and P₀ is the optical power in the FOG. It is critical to maintain P₀ otherwise it manifests as a false rotation rate ΔΘ_{R}.

An additional consideration for maintaining power levels of the FOG is the requirement for maintaining a minimum power level at the gyroscope's photodetector under all operating conditions. These conditions may include, for example, shock, vibration, temperature, and humidity, and may cause optical losses of the FOG to change. These changes in optical losses may require an adjustment to the optical power of the FOG to maintain specified performance levels. More specifically, the optical power is one aspect of maintaining and meeting the Angle Random Walk (ARW) performance specification of the FOG.

The maintenance of power in a 3-axis FOG system presents power balancing challenges. Conventionally, an Inertial Measurement Unit (IMU) utilizing open loop fiber optic gyroscopes may require three sources to provide power to three individual fiber optic gyroscopes. This design topography is costly and laborious in production.

### SUMMARY

The described embodiments are directed to an integrated modulator structure incorporated on the power delivery sections of a photonic fiber optic gyroscope (FOG) for amplitude balancing and control of a light signal delivered to the FOG components. The example embodiments described herein use only one source across three individual FOGs, while enabling each FOG to accomplish independent power gain adjustments, which may minimize bias error and maintain performance (more specifically angle random walk) requirements.

Amplitude balancing may be done to compensate for short-term light power fluctuations (e.g., due to system temperature excursions), and long-term power fluctuations (e.g., changes over the lifetime of the system). In one embodiment, an adaptive loop may be used to maintain a constant or near-constant level of light power delivered to each of the the photonic FOG circuits. This type of arrangement is made possible with a photonic integrated circuit (PIC) FOG optical architecture, due to the strict optical path length differences that are apparent in all fiber designs. The described embodiments facilitate simultaneous or near-simultaneous balancing of one or more light paths based on a single source, which may result in cost savings (due to the use of fewer sources), and power savings (a single, albeit larger super luminescent diodes (SLDs) may use less power than three individual SLDs).

The described embodiments allow monolithic integration of power adjustment in a photonic FOG, and in intrinsic and extrinsic interferometric based sensors that require distributed power control. The described embodiment facilitates the use of one source to be used to drive 1 to N number of fiber optic gyroscope axes, which may eliminate the laborious splicing required in three source systems. The described embodiments may facilitate finite gain control of the power in the interferometric circuit associated with each FOG axis without changing the carrier density of the source. Maintenance of wavelength, spectral linewidth and physical properties such as power consumption and heat dissipation can be maintained while allowing variable power to each sensing axis. The described embodiments may further facilitate increased bias stability of open loop fiber optic gyroscopes when compared to topographies which depend on direct power changes of the source. The described embodiments may further allow for monolithic integration of source and photonic FOGs without external source circuits.

In one aspect, the invention may be a light amplitude control system for use in a photonic integrated circuit (PIC)-based fiber optic gyroscope (FOG). The light amplitude control system may comprise one or more 2×2 PIC-based FOG optical circuits, and a PIC-based modulator assembly. The PIC-based modulator assembly may be configured to receive one or more input light signals, and to produce one or more output light signals that (i) correspond to the one or more input light signals and (ii) are conveyed to the one or more 2×2 PIC-based FOG optical circuits. Each of the one or more output light signals may have an amplitude that is a modified version of an amplitude of the corresponding input signal.

The one or more 2×2 PIC-based FOG optical circuits and the PIC-based modulator assembly may be disposed on a common PIC substrate. The one or more 2×2 PIC-based FOG optical circuits may be disposed on a first PIC substrate, and the PIC-based modulator assembly may be disposed on a second PIC substrate.

The light amplitude control system may further comprise a one port to three port (1:3) coupler configured to receive a source light signal from a light source, to split the source light signal into two or more substantially equal composite light signals, and to provide the two or more composite light signals to the PIC-based modulator assembly as the one or more input light signals. The light source may be a super luminescent diode (SLD). The PIC-based modulator assembly may comprise an optical modulator associated with each of the one or more output light signals. Each optical modulator may be configured to modify the amplitude of the corresponding input signal to produce the associated output light signal.

Each optical modulator may comprise a Mach-Zehnder Interferometer (MZI) configuration modulator. The MZI configuration modulator may comprise at least one of (i) a cascade MZI, (ii) a parallel MZI, (iii) an MZI-based ring resonator cavity, and/or combinations thereof. The MZI configuration modulator may be based on at least one of (i) thermo-optic phase shifter-based modulation, PN junction-based modulation, or absorption-based modulation. The MZI configuration modulator may comprise a first optical path and a second optical path. The first optical path may be effectively within a decoherence length of the second optical path. An integrated refractive index-based modulator may be associated with the first optical path and no optical modulator is associated with the second optical path. A first integrated refractive index-based modulator may be associated with the first optical path, and a second integrated refractive index-based modulator may be associated with the second optical path.

An integrated refractive index-based modulator that is associated with the MZI configuration modulator may be constructed as one of (i) an in-plane structure or (ii) an overlay structure. An electro-absorptive modulator may be associated with at least one optical path of the MZI configuration modulator. Each optical modulator may comprise at least one of an electro-absorptive modulator and/or an electro-refractive modulator.

The light amplitude control system may further comprise a controller configured (i) to receive information about amplitude of light along an optical path associated with each optical modulator, and (ii) to send a control signal to each optical modulator. Each optical modulator may be configured to modify the amplitude of the corresponding input signal based on the control signal. The controller may be configured to generate the respective control signal to each optical modulator to balance optical power across the optical paths associated with the one or more output light signals. Each optical modulator may control the amplitude of light propagating in its respective optical path independent of optical paths associated with other optical modulators. The optical modulator may be an electro-absorptive modulator implemented directly in an optical path between one of the one or more input light signals and one of the one or more output light signals.

In another aspect, the invention may be a PIC-based modulator assembly. The PIC-based modulator assembly may comprise an optical splitter configured to receive an input light signal and to produce one or more output light signals therefrom. The PIC-based modulator assembly may further comprise an optical path module configured to receive the one or more output light signals from the optical splitter, and to produce one or more output light signals that (i) correspond to the one or more input light signals and (ii) are conveyed to the one or more 2×2 PIC-based FOG optical circuits, each of the one or more output light signals having an amplitude that is a modified version of an amplitude of the corresponding input signal.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates an example embodiment of a single-axis 2×2 optical FOG circuit according to the invention.

FIG. 2 illustrates an example embodiment of a 3-axis FOG system according to the invention.

FIG. 3A illustrates an example embodiment of a basic Mach-Zehnder Interferometer (MZI) configuration according to the invention.

FIG. 3B shows an example embodiment of a PN junction-based modulator according to the invention.

FIG. 4 shows a high-level diagram of an example embodiment of a power balanced, 3-axis photonic FOG system, according to the invention.

FIG. 5 shows a high-level diagram of another example embodiment of a power balanced, 3-axis photonic FOG system, according to the invention.

### DETAILED DESCRIPTION

A description of example embodiments follows.

The teachings of all patents, published applications and references cited herein are incorporated by reference in their entirety.

The described embodiments are directed to an integrated modulator structure incorporated on the power delivery sections of a photonic fiber optic gyroscope (FOG) for amplitude control of a light signal delivered to the FOG components. A photonic FOG may alternatively be referred to herein as a photonic integrated circuit (PIC) FOG. The integrated modulator structure may comprise a Mach-Zehnder Interferometer (MZI) configuration, although other modulator architectures suitable for dynamically adjusting the amplitude of a propagating light signal may alternatively be used. MZI based structures may include cascade MZI, parallel MZI, MZI-based ring resonator cavities, and any combination of MZI structures to functionalize a phase shift power tuning capability.

An MZI modulator is designed to work with light sources that have high temporal coherence (e.g., lasers). FOGs, on the other hand, require a broadband source that exhibits high spatial coherence but poor temporal coherence, which presents a problem for use with a MZI configuration modulator. The inherent decoherence length (L_{DC}) of a light source is determined as:

$${L}_{D C} = \frac{( {λ}^{2} )}{Δ λ} .$$

So for an MZI structure to work in a FOG, the optical paths in the MZI need to effectively be within a decoherence length of each other to avoid biased behavior and subsequent offset power output. For example, a FOG with a source whose center wavelength is 825 nm and full width at half maximum (FWHM) of 25 nm would have a coherence length of 30.9 μm. A device with all fiber components generally cannot implement and maintain such a small optical path difference. Such an optical path difference is easily accomplished with a photonic FOG waveguide architecture. A photonic FOG therefore facilitates the practical use of such MZI structures for power balancing in FOG systems.

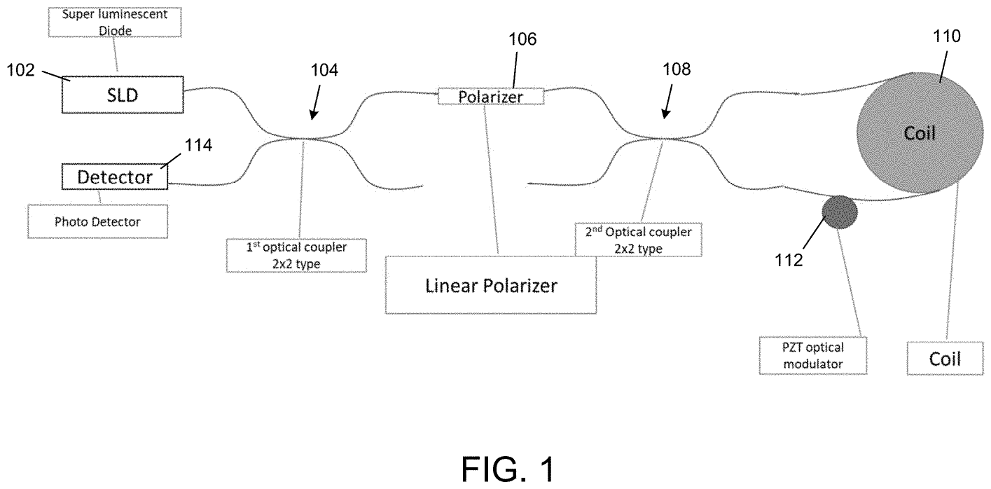

FIG. 1 illustrates an example embodiment of a single-axis 2×2 optical FOG circuit, comprising a super luminescent diode (SLD) 102, a first 2×2 (i.e., two inputs, two outputs) optical coupler 104, a polarizer 106, a second optical coupler 108, a fiber coil 110, a PZT optical modulator 112, and a photodetector 114. The “2×2” designation for the “2×2 optical FOG circuit” refers to the fact that the optical circuit shown in FIG. 1 has two ports at one end (corresponding to the SLD 102 and the detector 114), and two ports at the other end (corresponding to the two ports of the fiber coil 110).

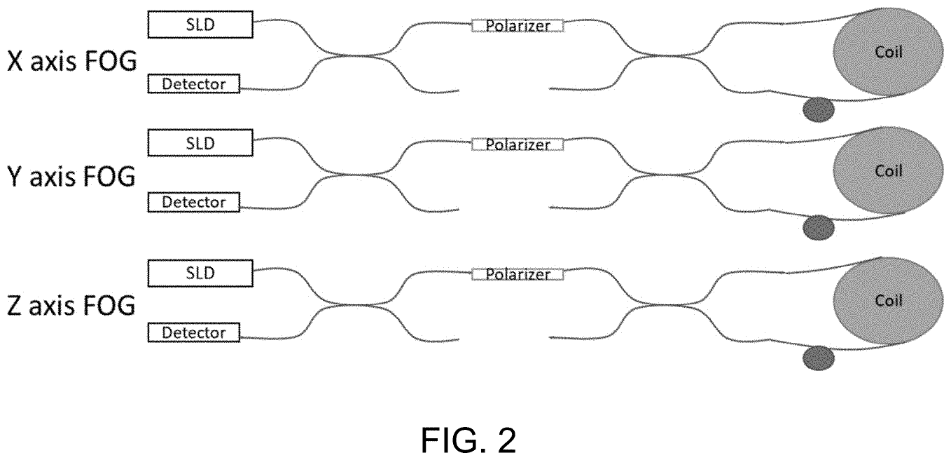

A three-axis system for an Inertial Measurement Unit (IMU) or an Inertial Navigation System (INS) may require three of the individual optical FOG circuits depicted in FIG. 1. An example of this type of conventional all-fiber or photonic 3-axis FOG system is shown in FIG. 2, in which three SLD components, one for each individual FOG circuit, are required. Amplitude control for a three-axis system as depicted in FIG. 2 would need to be accomplished by dynamically adjusting the output amplitude of each respective SLD source.

In the described embodiments, a single light source may be used to generate light for all three of the individual axis photonic FOG circuits. In an example embodiment, a 1×3 optical splitter (also referred to herein as a ‘coupler’) may receive an optical signal from the single source, separate the received optical signal into three signals, each of which is approximately one third (33%) of the total power of the received signal, and direct each of the separate signals into an output leg of the coupler. This type of coupler is conventionally available in both fiber-based systems and PIC-based systems. Fiber-based 1×3 or 3×3 couplers can be fabricated utilizing either Single mode (SM) or Polarization maintaining (PM) fiber. The split ratio of such a coupler can be tuned and adjusted during fabrication, but the desired split ratio is difficult to maintain. An advantage of the MZI power balancing scheme described herein is the ability to compensate for coupler offsets in manufacturing, thereby improving the yield of coupler fabrication.

In a photonic FOG, a 1×3 coupler as described herein can be fabricated with high accuracy, and although the power split ratio typically does not need to be dynamically compensated, the power balancing across the individual axis photonic FOG circuits must be maintained. The coupled portion of the FOG can be implemented either with an MZI modulator power balancing subsystem on a common PIC or separately. This is advantageous for systems where the FOG circuit is remotely mounted away from the source driver and corresponding electronics.

The phase balancing Mach Zehnder modulator in an example embodiment may be responsible for the adjustment of power in real time via the phase shifting provided by the modulator. As described below, several candidate modulator architectures may be used.

In the case of a refractive index, silicon-based optical modulator, a Mach Zehnder interferometer structure may be created with one leg of the modulator having an integrated refractive index-based modulator. A coupler splits a single light path into two branch paths, then recombines the two branch paths back into a single path. When one of the branch paths is modulated different from the other path, then the power amplitude of the signal in the recombined path will be modified. This modulator can be constructed via, for example, lead zirconate titanate (PZT) material (in-plane) or PZT stress induced refractive index changes (overlay), or any other refractive index type modulator known in the art. A phase shift in one leg of the MZI effectively changes the output amplitude of the structure.

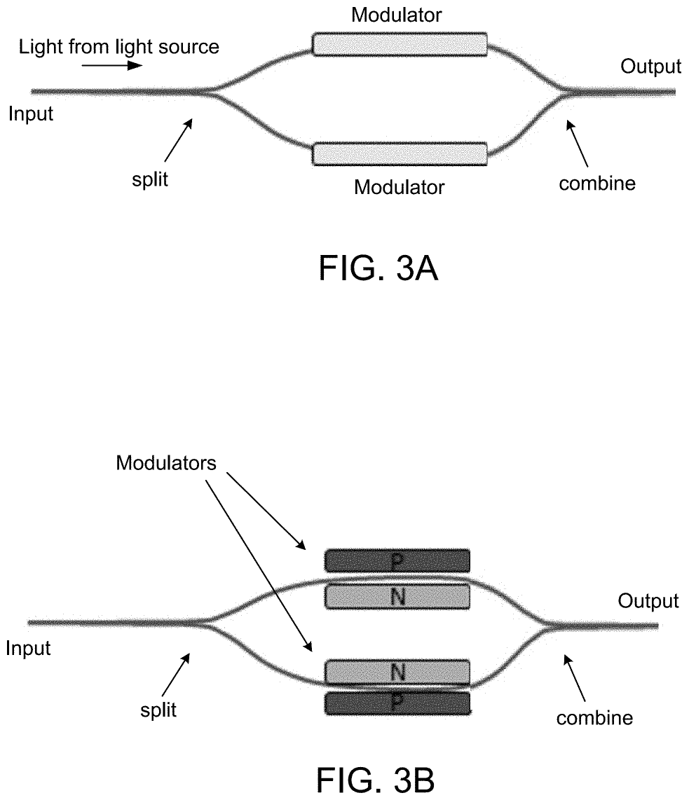

FIG. 3A illustrates an example embodiment of the above-described modulator implementation, in a basic MZI configuration, with each of the branch paths configured to adjust the phase of the individual branch path and subsequently the output amplitude. In this example embodiment the light signal propagates from left to right as indicated, although it should be understood that the propagation direction could alternatively be right to left. In some embodiments, the phase in only one branch path may be adjusted to implement a desired amplitude change in the output, with either the modulator in the other branch path inactive or not included. In other embodiments, the modulators in both branch paths may be adjusted to produce a desired amplitude change in the output.

FIG. 3B shows an example embodiment of a PN junction-based modulator (an electro-absorptive modulator), which can alternatively be utilized instead of direct refractive index changing the waveguide. The use of such an electro-absorptive modulator is possible because in the example embodiments the FOG is implemented on a photonic integrated circuit (PIC). By contrast, a fiber-based FOG would likely be limited to the use of, for example, lithium niobite-based devices. The use of a PIC FOG platform facilitates the use of a variety of modulator techniques/implementations, e.g., electro-refractive and absorptive carrier depletion implementations, which are not available with a fiber-based implementations.

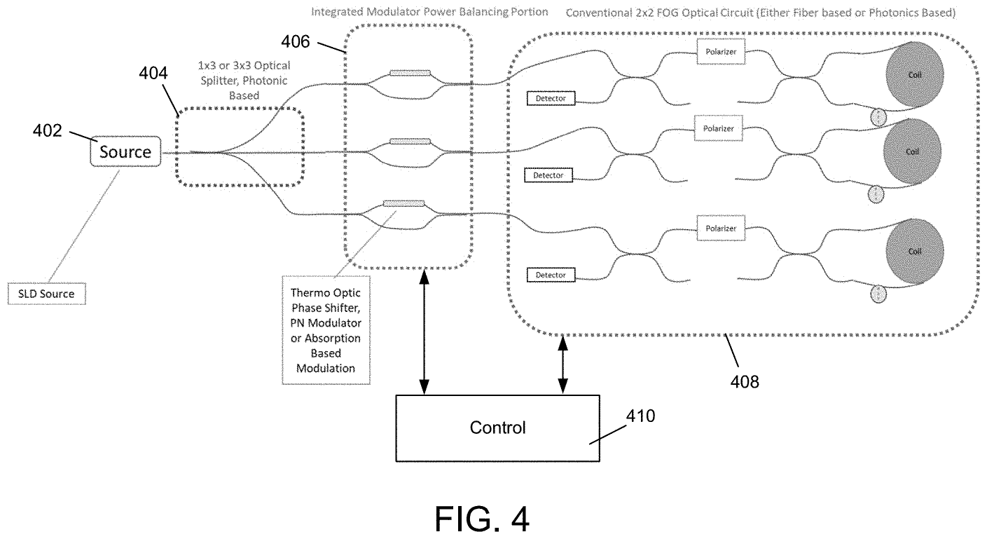

FIG. 4 shows a high-level diagram of an example embodiment of a power balanced, 3-axis photonic FOG system. The FOG system may comprise a number of subsystems, for example of a light source 402, a 1×3 coupler 404, integrated modulator portion of MZI or nested MZIs 406 (as previously described) followed by the conventional 2×2 FOG optical circuits 408. The MZI portion 406 may comprise thermo-optic phase shifter-based modulation, PN-based modulation, or absorption-based modulation. A controller 410 may be implemented to receive information about the amplitude of light at various points along the paths through the MZI portion 406 and the FOG optical circuits 408, and to send driver and/or control signals to the modulators within the MZI portion 406 to control the amplitude of the light in the optical path associated with each respective modulator. The controller 410 may be implemented on the PIC substrate that hosts the other PIC devices described herein, or the controller 410 may be implemented separate from the PIC substrate and

In some embodiments, the subsystems depicted in FIG. 4 may all be implemented on a single PIC. In other embodiments, one or more of the individual subsystems may be implemented on separate PIC devices, with the separate PIC devices connected with optical fiber or other optical waveguides. In some embodiments, components that are likely to dissipate heat during operation (e.g., the SLD and the modulators) may be arranged separate from passive components (e.g., 1×3 coupler 404 and 2×2 FOG optical circuits 408), so that one or more of the active (heat-dissipating) components is disposed on a first PIC, and one or more of the passive devices is disposed on a second PIC. An example photonic integrated circuit (PIC) FOG may incorporate the conventional 3-axis IMU or INS system into one chip, either with an onboard 1×3 coupler to utilize a single source, or an external source and 1×3 coupler.

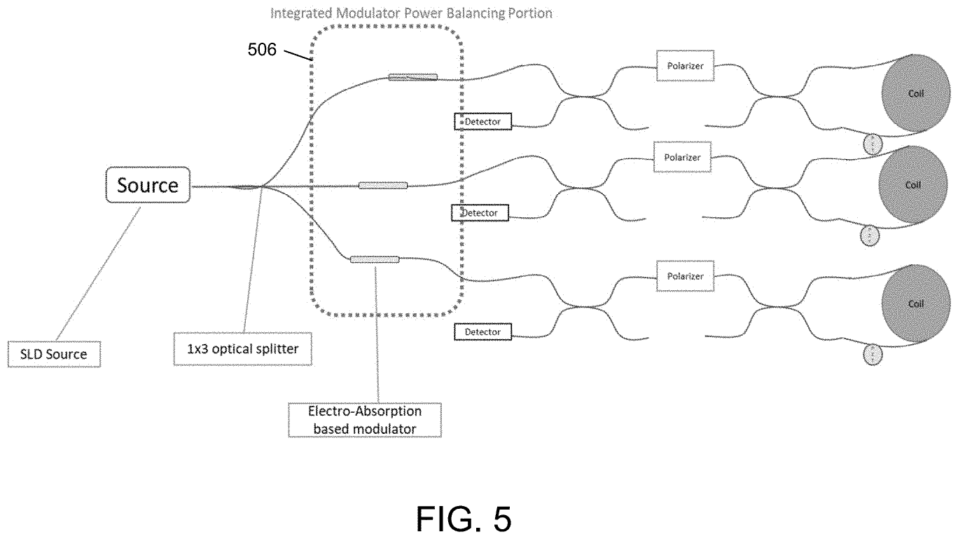

In the case of an electro-absorptive modulator (e.g., the PN junction-based modulator depicted in FIG. 3B), the modulator assembly 506 can be implemented directly in the source to interferometer path, as shown in the system level embodiment depicted in FIG. 5. It should be understood that in general, other techniques known in the art for adjusting the amplitude of light propagating in a path may alternatively be used.

While example embodiments have been particularly shown and described, it will be understood by those skilled in the art that various changes in form and details may be made therein without departing from the scope of the embodiments encompassed by the appended claims.

What is claimed is:

1. A light amplitude control system for use in a photonic integrated circuit (PIC)-based fiber optic gyroscope (FOG), comprising:
one or more 2×2 PIC-based FOG optical circuits;
a PIC-based modulator assembly configured to receive one or more input light signals, and to produce one or more output light signals that (i) correspond to the one or more input light signals and (ii) are conveyed to the one or more 2×2 PIC-based FOG optical circuits, each of the one or more output light signals having an amplitude that is a modified version of an amplitude of the corresponding input signal.

2. The light amplitude control system of claim 1, wherein the one or more 2×2 PIC-based FOG optical circuits and the PIC-based modulator assembly are disposed on a common PIC substrate.

3. The light amplitude control system of claim 1, wherein the one or more 2×2 PIC-based FOG optical circuits are disposed on a first PIC substrate, and the PIC-based modulator assembly is disposed on a second PIC substrate.

4. The light amplitude control system of claim 1, further comprising a one port to three port (1:3) coupler configured to receive a source light signal from a light source, to split the source light signal into two or more substantially equal composite light signals, and to provide the two or more composite light signals to the PIC-based modulator assembly as the one or more input light signals.

5. The light amplitude control system of claim 1, wherein the light source is super luminescent diode (SLD).

6. The light amplitude control system of claim 1, wherein the PIC-based modulator assembly comprises an optical modulator associated with each of the one or more output light signals, and wherein each optical modulator is configured to modify the amplitude of the corresponding input signal to produce the associated output light signal.

7. The light amplitude control system of claim 6, wherein each optical modulator comprises a Mach-Zehnder Interferometer (MZI) configuration modulator.

8. The light amplitude control system of claim 7, wherein the MZI configuration modulator comprises at least one of (i) a cascade MZI, (ii) a parallel MZI, (iii) an MZI-based ring resonator cavity, and/or combinations thereof.

9. The light amplitude control system of claim 7, wherein the MZI configuration modulator is based on at least one of (i) thermo-optic phase shifter-based modulation, PN junction-based modulation, or absorption-based modulation.

10. The light amplitude control system of claim 7, wherein the MZI configuration modulator comprises a first optical path and a second optical path, wherein the first optical path is effectively within a decoherence length of the second optical path.

11. The light amplitude control system of claim 10, wherein an integrated refractive index-based modulator is associated with the first optical path and no optical modulator is associated with the second optical path.

12. The light amplitude control system of claim 10, wherein a first integrated refractive index-based modulator is associated with the first optical path and a second integrated refractive index-based modulator is associated with the second optical path.

13. The light amplitude control system of claim 7, wherein an integrated refractive index-based modulator that is associated with the MZI configuration modulator is constructed as one of (i) an in-plane structure or (ii) an overlay structure.

14. The light amplitude control system of claim 7, wherein an electro-absorptive modulator is associated with at least one optical path of the MZI configuration modulator.

15. The light amplitude control system of claim 6, wherein each optical modulator comprises at least one of an electro-absorptive modulator and/or an electro-refractive modulator.

16. The light amplitude control system of claim 6, further comprising a controller configured (i) to receive information about amplitude of light along an optical path associated with each optical modulator, and (ii) to send a control signal to each optical modulator, wherein each optical modulator is configured to modify the amplitude of the corresponding input signal based on the control signal.

17. The light amplitude control system of claim 16, wherein the controller is configured to generate the respective control signal to each optical modulator to balance optical power across the optical paths associated with the one or more output light signals.

18. The light amplitude control system of claim 16, wherein each optical modulator controls the amplitude of light propagating in its respective optical path independent of optical paths associated with other optical modulators.

19. The light amplitude control system of claim 6, wherein the optical modulator is an electro-absorptive modulator implemented directly in an optical path between one of the one or more input light signals and one of the one or more output light signals.

20. A PIC-based modulator assembly, comprising:
an optical splitter configured to receive an input light signal and to produce one or more output light signals therefrom;
an optical path module configured to receive the one or more output light signals from the optical splitter, and to produce one or more output light signals that (i) correspond to the one or more input light signals and (ii) are conveyed to the one or more 2×2 PIC-based FOG optical circuits, each of the one or more output light signals having an amplitude that is a modified version of an amplitude of the corresponding input signal.
